(19) United States
(12) Patent Application Publication
(10) Pub. No.: US 2011/0049071 A1
(43) Pub. Date: Mar. 3, 2011

(54) BLINDS

(75) Inventors: Chris Hart, Queensland (AU); Henk Dogger, Queensland (AU)

(73) Assignee: Spp Industries Holdings Pty Ltd

(21) Appl. No.: 12/808,734

(22) PCT Filed: Dec. 10, 2008
(86) PCT No.: PCT/AU2008/001820

§ 371 Date: Nov. 11, 2010

(30) Foreign Application Priority Data
Dec. 17, 2007 (AU) 2007906900

(51) Int. Cl. A47H 13/00; B23P 11/00

(52) U.S. Cl. 211/124; 29/525.08

(57) ABSTRACT

A blind rail to which blind fabric can be attached is disclosed. The rail has a main slot into which an edge portion of the blind fabric can be inserted, and an insert which can be inserted into and securely retained in the main slot with the edge portion to securely attach the blind fabric to the rail. The rail also has an additional slot into which a fold of the blind fabric can be inserted. The way the folded fabric can be secured in the additional slot enables the blind fabric to be attached to the blind rail of the present invention in two different configurations. In one configuration, most of the blind rail remains exposed to give the blind rail a ‘naked’ aesthetic. In the other configuration, the blind fabric may wrap around most of the blind rail giving the blind rail a covered aesthetic.

### FIELD OF THE INVENTION

The present invention relates to the manufacture of blinds. The invention may be particularly applicable to (but not necessarily limited to) the manufacture of Roman blinds and roller blinds.

### BACKGROUND

In general, blinds provide a covering for windows, glass doors and the like. Blinds operate to “block out” light (i.e. prevent light from entering through the window or door etc), or to prevent people from seeing in through the window or door. A range of different types of blinds exist. Two common types of blinds are “Roman blinds” and “roller blinds”. FIG. 1 illustrates a conventional Roman blind, and FIG. 2 illustrates a conventional roller blind.

In FIG. 1, the Roman blind includes a sheet of pleated fabric 1. The fabric 1 is what provides the covering to prevent light from entering through the window etc when the blind is down. The top edge of the fabric 1 is attached to and hangs from a head rail 2. The head rail 2 is fixed in position and is typically mounted to the wall above the window or door. The way in which the fabric 1 normally attaches to the head rail 2, and the way in which the bottom edge 3 is conventionally finished, will be described further below. In between the top and the bottom edges of the fabric in the Roman blind, folds in the fabric are inserted into a series of intermediate battens 4. In FIG. 1, there are four battens 4. However, this is just an example and there could be a different number. One way in which the folds in the fabric can be inserted into the battens 4 is described in our co-pending application number PCT/AU2007/001199. The battens 4 are supported by an arrangement of “pull strings” 5 which extend vertically from the head rail 2. In some cases, the fabric 1 curves slightly up where it connects to each batten 4, thus providing a pleated appearance. Other blinds to not curve up in this way and therefore provide a flatter appearance when the blinds down.

The pull strings 5 extend down from the head rail 2 through a series of islets 6 connected to the battens 4. If it is desired to lift the blind to allow light into the room etc, the pull string 5 can be pulled (normally a length of the pull string hanging down one side of the blind is pulled down) and this causes the blind to lift. As the blind lifts, the fabric 1 gathers neatly along each of the battens 4, each of which contains folds in the fabric.

Referring now to FIG. 2 which illustrates a “roller blind”, it can be seen that the roller blind also has a sheet of fabric 1 which provides the covering to prevent light from entering the window etc when the blind is down. The fabric 1 at the top of the blind is also attached to a head rail 2 which, again, is usually mounted to the wall above the window. However, unlike the Roman blind illustrated in FIG. 1, the fabric 1 in FIG. 2 hangs straight down (rather than being pleated). Also, the fabric 1 in the roller blind does not simply hang from the head rail 2. Instead, the head rail 2 is able to rotate about its longitudinal axis and the fabric 1 is able to wind on and off the head rail 2. To do this, the head rail 2 can be rotated using the looped chain or cord 7. Pulling on one side of the loop will cause the head rail 2 to rotate in one direction which will “wind in” the blind fabric 1 thereby lifting the blind and allowing light to enter the window etc. Conversely, pulling on the other side of the loop will cause the head rail 2 to rotate in the other direction which will allow more of the fabric 1 to “wind off” the head rail thereby lowering the blind down to cover the window. The way in which the fabric 1 attaches to the head rail 2, and the way in which the bottom edge 3 is conventionally finished, will be described further below.

FIGS. 3-5 illustrate various conventional ways in which the bottom edge of the fabric 1 can be finished. In each case, a relatively stiff or heavy member or component is secured to the bottom edge of the blind. Among other things, this helps the fabric 1 at the bottom of the blind to hang straight, and prevents it from flapping in the breeze etc. For convenience, the various relatively stiff or heavy members or components used in finishing the bottom edge of the fabric 1 of the blind and described in FIGS. 3-5 will be referred to generically as the “base rail” 9.

In FIG. 3, the base rail 9 comprises an elongate plastic rod of generally rectangular cross-section. As an indication, rods conventionally used for this purpose are often between 6 mm and 15 mm high and 1 mm thick and as wide as the fabric of the blind. The rod 9 is affixed to the bottom edge of the fabric via a strip of double sided tape 8. In some cases, the rod 9 may be simply adhered to the bottom edge of the fabric in this way and nothing more is done. In other instances, a second strip of double sided tape (not shown) is applied to the other side of rod 9 and the rod is then “rolled up” (as indicated by the arrow in FIG. 3) so that the fabric 1 folds around the bottom of the rod and the tape on the other side of the rod adheres to the fabric as well. The rod with the fabric is sometimes then inserted into an extruded aluminium rail (not shown) that can have any cross-sectional shape and which is typically as wide as the blind. Thus, the rod 9 can be hidden from view giving a slightly more aesthetic finish.

FIG. 4 illustrates an alternative method which is often used for finishing the bottom edge of the fabric 1. In FIG. 4, the base rail 9 is a plastic “spline”. It is inserted over the bottom edge of the fabric as shown. The spline 9 has tabs which extend up on one or both sides of the fabric. It is then sewn or stitched to the fabric as shown to secure it in place. Plastic splines used for this purpose may be made from clear plastic, or some other opaque or coloured plastic, depending on the desired aesthetic. This plastic spline is sometimes then inserted into an extruded aluminium rail (not shown) that can have any cross-sectional shape and which is typically as wide as the blind. Thus, the spline 9 can be hidden from view giving a slightly more aesthetic finish.

FIG. 5 illustrates yet another method that is often used to finish the bottom edge of the fabric 3. The method illustrated in FIG. 5 uses a base rail 9 in the form of a rod similar to that illustrated in FIG. 3. However, when the method shown in FIG. 5 is used, the rod 9 is often made from wood rather than plastic. In this method, the bottom edge of the fabric is effectively wrapped around underneath the rod 9 and stitched in place as shown.

FIGS. 3-5 show conventional ways for finishing the bottom edge of the fabric 1. In blinds such as Roman blind where the head rail does not rotate, similar methods are often used to secure the top edge of the fabric to the head rail 2.

FIG. 6 illustrates a conventional method for securing the top edge of the fabric 1 to a rotating head rail 2 of the kind used in roller blinds. In FIG. 6, the top edge of the fabric is typically simply adhered to the cylindrical outer-surface of the head rail 2 using double sided tape (not visible) or as per the methods for attaching to the bottom rail as described above.

The conventional methods described above for attaching the base rail to the bottom edge of the fabric involve a number of problems. One significant problem is the large amount of labour that is required to attach the base rail to finish the edge. For instance, the tasks of correctly positioning the double sided tape 8 and adhering the rod 9 in place, and performing the stitching operations, are particularly labour-intensive. It would be preferable if the base rail (whatever its form) could be connected in a way which required less labour, and which could therefore allow blinds to be manufactured more quickly and at lower cost. There is also a limit to the aesthetic effects that can be achieved using the above-mentioned conventional methods, and it would be preferable if a choice between different aesthetic effects were available without changing the design or configuration of the base rail.

The method for securing the top edge of the fabric 1 to the rotating head rail 2 in roller blinds (as shown in FIG. 6) also has problems associated with it. One particular problem arises because the double sided tape used to secure the top edge of the fabric to the head rail can be, by itself, insufficient to retain the fabric to the head rail. Therefore, roller blinds conventionally have an excess of fabric so that there is 1-3 “winds” of fabric wound around the head rail even when the blind is lowered to cover the entire window. These excess winds of fabric around the head rail help to hold the fabric to the head rail. However, it is a common problem that the blind can be “over wound” so that the excess winds are rolled off the head rail along with the rest of the fabric. When this happens, there is a significant danger that the fabric could simply detach and pull away from the head rail. In order to address this problem, mechanisms called “cord locks” have been fitted to many roller blinds. Cord locks operate so that the loop of chain or cord 7 which is pulled to raise/lower the blind can only be moved between two extremes. This prevents the head rail from rotating enough to wind the excess fabric of the head rail. However, whilst these cord locks can reduce the risk of the fabric being wound all the way off and detaching from the head rail, they often also introduce further problems. In particular, in blinds which have a cord lock, the loops of chain or cord can pose a significantly increased risk to young children who may place the loop around their neck. Into these instances, this could lead to the child being choked or hanged, and for this reason, roller blinds having cord locks are being phased out by safety regulations in some countries.

It is an object of the present invention to provide a blind rail, and an associated method for attaching blind fabric to a rail, which may overcome or reduce the above-mentioned problems, or which may at least provide a useful or commercial choice in the marketplace. Further objectives of the invention may be evident from the following description.

It will be clearly appreciated that any reference herein to previous or conventional methods, apparatuses, practices, problems or other information does not constitute an acknowledgement or admission that any methods, apparatuses, practices, problems or other information, or any possible combination thereof, formed part of the common general knowledge in the field, or is otherwise admissible prior art, whether in Australia or in any other country.

### DESCRIPTION OF THE INVENTION

In one form, the present invention resides broadly in a blind rail to which blind fabric can be attached, the rail having a slot into which an edge portion of the blind fabric can be inserted, and an insert which can be inserted into the slot with the edge portion to securely attach the blind fabric to the rail.

In another form, the present invention resides broadly in a method for attaching an edge portion of the fabric of a blind to a rail of the blind by inserting the edge portion of the blind fabric into a slot in the blind rail and then inserting an insert into the slot with the edge portion to retain the blind fabric to the rail.

In both of these forms of the invention, when the edge portion of the blind fabric is inserted into the slot and the insert is then inserted, some of the fabric may become trapped/squeezed between an edge, surface or other part of the slot and an edge, surface or other part of the insert. Trapping the fabric between part of the slot and part of the insert may assist in securing the blind fabric to the rail.

The present invention allows the fabric to be securely attached to the rail without the time-consuming and labour-intensive taping or sewing operations which are conventionally used (as described above). An additional benefit of some embodiments of the present invention is that, if it is necessary to detach the fabric from the rail, this can be done by simply removing the insert from the slot, thereby freeing the fabric. In contrast, with the conventional methods described above, it can be much more difficult to separate the fabric from the rail because this can involve undoing the stitches of the sewing, or separating the surface which are stuck together by the adhesive of the tape.

It is envisaged that the blind rail will typically be the head rail or base rail (or both) of a Roman blind or roller blind. However, no particular limitation is meant thereby, and the invention could potentially be used for any other blind rail, such as an intermediate rail, side edge rail, batten etc, and/or on any other form of blind which uses fabric to provide covering over a window door etc.

The blind rail may be made from any suitably strong and stiff material. Strength and stiffness are perhaps more important where the rail is used for the head rail of the blind. It is envisaged that the most common materials will be metal and plastic. In preferred embodiments, the rail will be extruded from lightweight aluminium alloy. The insert may also be made of any suitably strong and stiff material. However, unlike the rail which is preferably extruded aluminium or similar like, it is envisaged that the insert will typically (although not necessarily) be made from a plastic or polymer material, perhaps nylon or something similar. Materials such as this are somewhat more compliant than metal, and this may assist the insert to function, particularly where the insert or part thereof is required (as it will be in many embodiments) to squeeze into the slot or squeeze against the sides or edges of the slot.

Like most blind rails, the blind rails used with the present invention will typically be elongate thin walled members. In embodiments where the rail comprises an elongate lightweight aluminium alloy extrusion, the extrusion will preferably have an open or hollow cross-section. This may reduce the amount of material in the rail, thereby reducing cost and weight.

The insert may be an elongate extruded “strip”-like component. The insert may have cross-sectional shape which allows it to be snugly received in the slot in the rail, possibly also leaving a portion of the cross-section outside the slot to effectively cover the slot.

The present invention operates to secure blind fabric to a blind rail. However, those skilled in this area will appreciate that the word “fabric” in the present context is not limited to woven cloth-type materials. Rather, in the context of the present invention, the “blind fabric” may be any sheet-like material capable of being used in a blind to provide a cover for a window or door etc. Therefore, for example, “blind fabric” could include rubber, plastic or polymer sheet-type materials, or even paper, all of which are capable of being used in blinds to provide the cover for windows of doors. Those skilled in the art will recognize that there are also other materials which would fall within the meaning of “blind fabric”.

In addition to the slot in the rail (referred to now as the main slot) which receives the edge portion of the blind fabric, the rail may also have an additional slot for receiving a fold of the blind fabric. The way in which the additional slot may receive a fold of the blind fabric may be similar to the way in which the folds of fabric are received in the battens 4 in FIG. 1. The folds in the fabric may be inserted into the additional slot in the rail in the same way as described in our co-pending application number PCT/AU2007/001199 to which reference may be had and which therefore requires no further explanation.

In embodiments which have an additional slot for receiving a fold of fabric (in addition to the main slot which receives the edge portion of fabric) the fold of fabric should often be inserted into the additional slot before the edge portion of the fabric is inserted into the main slot. The reason for this may be more clearly understood with reference to description of the preferred embodiment below.

Suitably, the present invention (particularly embodiments having an additional slot for receiving a fold of fabric and especially where the blind rail forms a base rail) may enable the blind fabric to be attached to the blind rail in different configurations. In one configuration, some or most of the blind rail may remain exposed to view to give the rail a “naked” appearance. In another configuration, the blind fabric may wrap around most of the blind rail hiding the rail from view and giving the blind rail a covered appearance.

### BRIEF DESCRIPTION OF THE DRAWINGS

FIGS. 1-6 relate to conventional arrangements used prior to the present invention and were described in the background section above. In FIGS. 1-6:

FIG. 1 illustrates a conventional Roman blind;

FIG. 2 illustrates a conventional roller blind;

FIG. 3 illustrates a first conventional method for attaching a base rail to the bottom edge of the blind fabric in which the base rail is a rod which is affixed to the edge of the fabric using a strip of double sided tape.

FIG. 4 illustrates an alternative method in which a plastic spline is inserted onto or over the bottom edge of the fabric as shown and then sewn or stitched to the fabric to secure it in place.

FIG. 5 illustrates yet another method which uses a similar rod to that illustrated in FIG. 3 and wherein the bottom edge of the fabric is effectively wrapped around underneath the rod and stitched in place.

FIG. 6 illustrates a conventional method for securing the top edge of the fabric to a rotating head rail of the kind used in roller blinds, wherein the top edge of the fabric is adhered to the cylindrical outer surface of the head rail using double sided tape.

FIGS. 7-10 illustrate certain embodiments of the present invention. However, it will be clearly understood that the description of the embodiments in FIGS. 7-10 is given for the purposes of illustration and example only, and the invention is not necessarily limited to or by the particular features described. In FIGS. 7-10:

FIG. 7 illustrates an embodiment of the invention where the rail is a base rail of a Roman blind or roller blind and the bottom edge of the blind fabric is arranged in a configuration that gives the base rail a “naked” appearance.

FIG. 8 illustrates the same embodiment of the invention illustrated in FIG. 7 (i.e. the rail is a base rail of a Roman blind or roller blind), but where the bottom edge of the blind fabric is arranged in an alternative configuration that gives the base rail a covered appearance.

FIG. 9 illustrates an alternative embodiment of the invention in which the rail has only the main slot, but where the cross-section of the rail is round making the rail potentially suitable for use as a head rail, for instance in a roller blind.

FIG. 10 illustrates yet another embodiment of the invention in which the rail has a main slot and an additional slot and, like the embodiment in FIG. 9, the cross-section of the rail is round making the rail potentially suitable for use as a head rail.

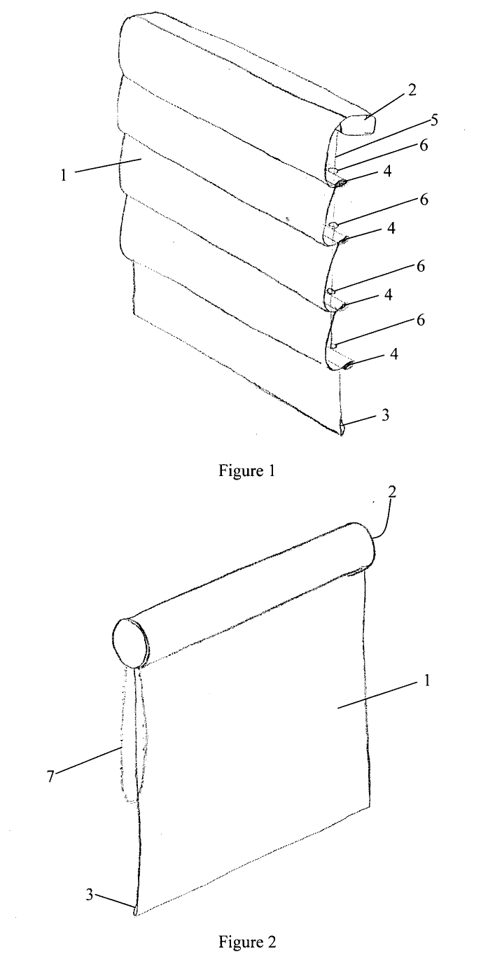

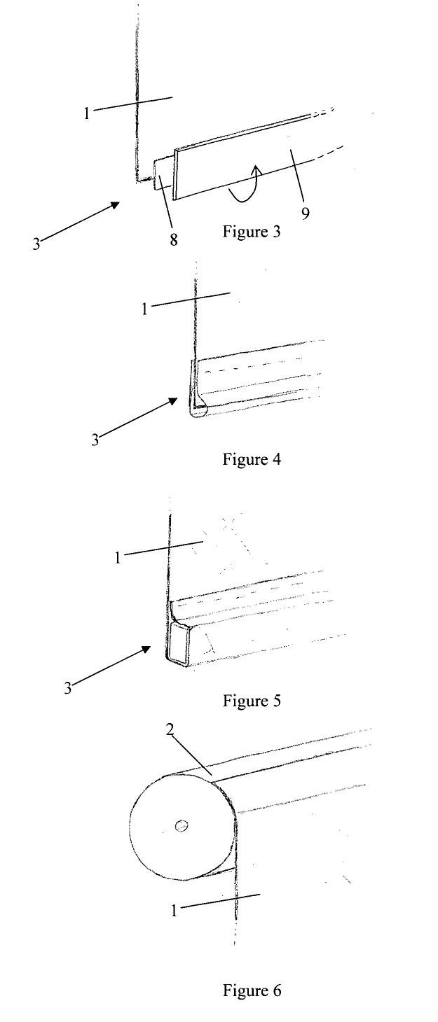

### DETAILED DESCRIPTION OF THE DRAWINGS

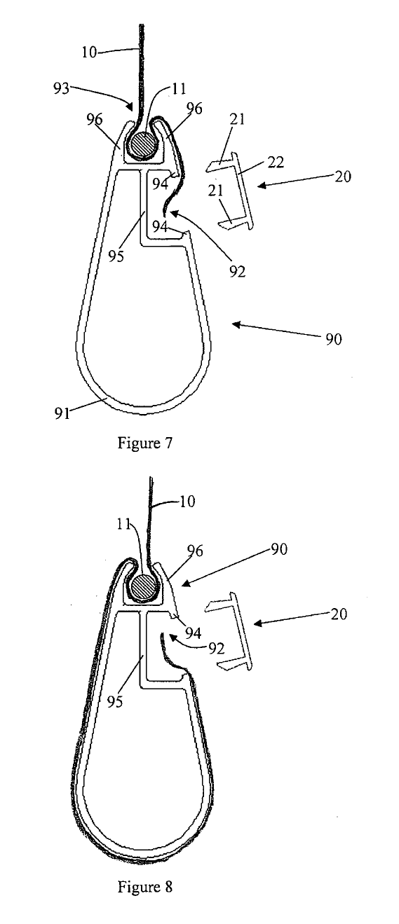

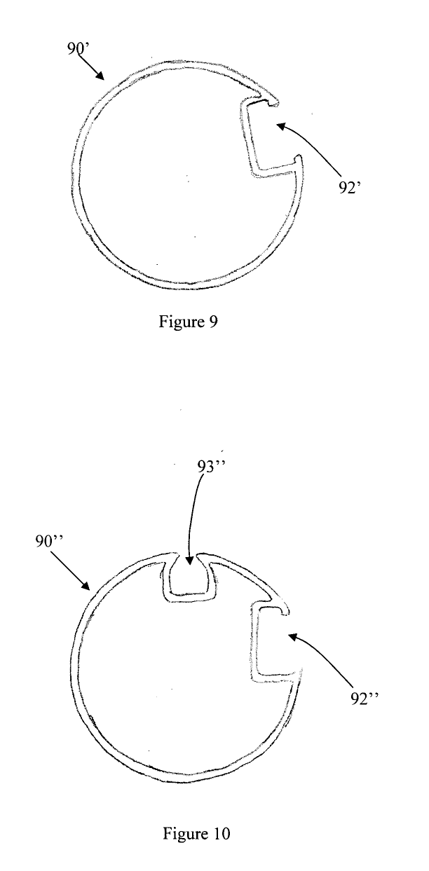

The elements of the blind shown in FIGS. 7-8 are the blind fabric 10, the base rail (generally designated by reference numeral 90), the insert (generally designated by reference numeral 20) and a rod 11 the purpose of which will be described further below. All of the elements in FIGS. 7-8 are shown in cross-sectional profile. In these figures, the left-hand side of the fabric and rail is the front side which is visible (i.e. the side which faces into the room). The right-hand side is the back of the blind and rail which faces the window.

It can be seen that the base rail 90 has a generally teardrop shaped cross-sectional profile. The rounded lower end 91 of the rail (which gives it the distinctive teardrop shape) exists partly for aesthetic reasons, but it also has a functional aspect. In particular, the rounded lower end 91 helps to evenly distribute the hanging weight of the rail 90 so that the rail hangs straight. Nevertheless, the thin walled extruded aluminium construction of the rail helps to keep the overall weight of the rail to a minimum.

The narrower upper portion of the rail includes two slots, namely the main slot 92 and the additional slot 93 (which will be referred to hereafter as the fold slot 93). The main slot 92 is formed in an upper portion of the back wall of the rail, and a metal section 95 forms the internal wall of the main slot 92. The fold slot 93 is formed by a pair of upwardly standing walls 96 and it opens vertically upwards from the top of the base rail 90.

Referring specifically to FIG. 7, it can be seen that the blind fabric in this configuration extends down from the main body of the blind before forming a tight fold which is imprisoned in fold slot 93 (i.e. prevented from pulling out of the fold slot 93) by rod 11 which runs substantially the length of the slot. The tight fold of fabric and the rod 11 are inserted into the fold slot 93 in the manner described in our co-pending application number PCT/AU2007/001199.

After the tight fold, and fabric proceeds back up and out through the opening of fold slot 93, and then folds over down the back of the rail 90. The bottom edge portion of the fabric then inserts into the main slot 92 as shown. The insert 20 can then be inserted into the main slot 92 to secure the bottom edge of the fabric in the main slot 92 as described further below.

It can be seen that the insert 20 comprises a pair of leg portions 21 and a cover portion 22. The leg portions 21 insert into the main slot 92, whereas the cover portion 22 extends over the opening in main slot 92 when the insert 20 is inserted. Each leg portion 21 is relatively thin where it connects to the cover portion 22, but thicker at the free end of the leg portion. When the insert 20 is forced into the main slot 92, the protruding edges 94 that form the mouth of main slot 92 force the leg members 21 to deflect inwardly. However, as the leg members 21 proceed further into the main slot 92, they are able to deflect back out and the outside of each leg engages with an edge 94 to prevent the insert 20 from pulling back out. It will also be seen that the bottom edge portion of the fabric 10 becomes squeezed in between the upper leg portion 21 of the insert and the edge 94 of the slot. Therefore, the lower edge of the fabric is trapped between the insert and the edge of the slot securing the fabric to the rail.

The insertion of the insert 20 into slot 92 is initially from the bottom edge 94 and then the top edge 94. Performing the insertion in this way applies pressure to the fabric causing the fabric to be pulled taut between the two slots 92 and 93 thereby adding to the aesthetics of the assembly.

The dimensioning of the slot 92 and the insert 20 allows for various deflections enabling the system to be used on different thicknesses, textures and stiffness of fabrics.

In FIG. 7, the fabric 10 only extends over a small portion of the back of the rail. Therefore, the entire front of the rail is exposed giving the rail a “naked” or “uncovered” appearance in this configuration. Depending on the desired aesthetic, the outside surface of the rail may have a simple brushed metal finish, or it may be painted, anodised or provided with some other colouring or patterning.

The configuration shown in FIG. 8 operates in much the same way as the configuration in FIG. 7 except that, after the tight fold, the fabric 10 extends out of the top of fold slot 93 and down the front face of the rail 90. The fabric then proceeds all way down around the bottom of lower portion 91 and back up the rear of the rail until the end of the fabric again extends into the main slot 92. The end of the fabric is then secured in the main slot 92 by the insert 20 in the same way as described above.

In this instance the insertion of the insert 20 into slot 92 is initially from the top edge 94 and then the bottom edge 94. Performing the insertion in this way applies pressure to the fabric causing the fabric to be pulled taut around the rail between the two slots 92 and 93 thereby adding to the aesthetics of the assembly.

Again, the dimensioning of the slot 92 and the insert 20 allows for various deflections enabling the system to be used on different thicknesses, textures and stiffness of fabrics.

Hence, in FIG. 8 the fabric extends around the full visible surface of the rail 90 giving the rail a covered appearance. In most cases, the pattern on the fabric 10 will continue on the portion of the fabric that extends around the rail such that the appearance of the rail is much the same as the rest of the blind.

Referring next to FIG. 9, it can be seen that the rail 90′ in this Figure has a substantially circular cross-section making it potentially suitable for use as the head rail of a roller blind or the like. The rail 90′ also incorporates one slot 92′. The slot 92′ is identical in configuration to the main slot 92 described above with reference to FIGS. 7-8. Therefore, an edge portion (for example a top edge portion) of the blind fabric could be secured to this rail in the same way as described above using an insert (the insert used in this embodiment is not shown, but could be the same as those described above).

Finally, referring to FIG. 10, it can be seen that the rail 90″ illustrated in this Figure is something of a combination of the rail 90 in FIGS. 7-8 and the rail 90′ in FIG. 9. For instance, the rail 90″ in FIG. 10 is similar to the rail 90′ in FIG. 9 insofar as it has a similar substantially circular cross-section making it potentially suitable for use as the head rail of a roller blind. However, the rail 90″ in FIG. 10 is similar to the rail 90 shown in FIG. 7-8 in that it incorporates not only a main slot 92″ but also an additional fold slot 93″. Therefore, the rail 90″ in FIG. 10 could incorporate a fold of fabric in a similar way to the rail 90 in FIGS. 7-8. This might be done to ensure that the fabric is attached even more securely to the rail 90″.

Those skilled in the art will recognize that various other changes and modifications could be made to the particular embodiments described without departing from the spirit and scope of the invention.

1. A blind rail to which blind fabric can be attached, the rail having a slot into which an edge portion of the blind fabric can be inserted, and an insert which can be inserted into and securely retained in the slot with the edge portion of the fabric to securely attach the fabric to the rail.

2. A blind rail as claimed in claim 1, wherein when the edge portion of the fabric is inserted into the slot and the insert is inserted, some of the fabric becomes trapped/squeezed between an edge, surface or other part of the slot and an edge, surface or other part of the insert.

3. A blind rail as claimed in claim 1, wherein removing the insert from the slot can enable the fabric to be detached from the rail.

4. A blind rail as claimed in claim 1, wherein the rail comprises the head rail or base rail of a Roman blind or roller blind.

5. A blind rail as claimed in claim 1, wherein the rail comprises a lightweight aluminium alloy extrusion having an open or hollow cross-section.

6. A blind rail as claimed in claim 1, wherein the insert is an elongate extruded “strip”-like component made from a plastic or polymer material.

7. A blind rail as claimed in claim 1, wherein the insert's cross-section has a pair of leg portions which insert into the slot, and a cover portion which extends at least partially over the slot when the insert is inserted.

8. A blind rail as claimed in claim 7, wherein each leg portion is relatively thin where it connects to the cover portion but thicker at its free end such that, when the insert is inserted into the slot, one or more edges of the slot at the mouth of the slot force the leg members to deflect inwardly but as the leg members move into the slot they deflect back out and the outside of each leg member engages with an edge of the slot to retain the insert in the slot.

9. A blind rail as claimed in claim 1, wherein the rail enables the blind fabric to be attached to the rail in different configurations.

10. A blind rail as claimed in claim 9, wherein the different configurations include one where some or most of the rail remains exposed to view, and one where the blind fabric wraps around the rail hiding at least a portion of the rail from view.

11. A blind rail as claimed in claim 1, wherein the rail has an additional slot for receiving a fold of the blind fabric.

12. A blind rail as claimed in claim 11, wherein the additional slot is located towards the top of the rail and/or opens upwards from at or near the top of the rail.

13. A method for attaching an edge portion of the fabric of a blind to a rail of the blind by inserting the edge portion of the fabric into a slot in the rail and then inserting an insert into the slot with the edge portion of the fabric to retain the blind fabric to the rail.

14. A method as claimed in claim 13, wherein the rail enables the blind fabric to be attached in different configurations and the insertion of the insert into the slot is initially from a bottom edge of the slot, or from the top edge of the slot, depending on the configuration.

15. A blind rail to which blind fabric can be attached, the rail having a slot into which an edge portion of the fabric can be inserted, the slot being adapted to receive an insert which can be inserted into and securely retained in the slot with the edge portion of the fabric to securely attach the blind fabric to the rail.

16. (canceled)
